(19) United States
(12) Patent Application Publication
(10) Pub. No.: US 2014/0014261 A1
(43) Pub. Date: Jan. 16, 2014

(54) METHOD OF MAKING A WINDOW BLIND

(71) Applicant: Hsiao-Yin CHEN, New Taipei City (TW)

(72) Inventor: Hsiao-Yin CHEN, New Taipei City (TW)

(21) Appl. No.: 14/030,192

(22) Filed: Sep. 18, 2013

Related U.S. Application Data
(63) Continuation-in-part of application No. 13/418,791, filed on Mar. 13, 2012.

(51) Int. Cl. E06B 9/262

(52) U.S. Cl. CPC E06B 9/262
USPC 156/227

(57) ABSTRACT

A method of making a window blind includes following steps. Firstly, plural base fabrics are cut out, each base fabric is provided with a first end surface and a second end surface, and two opposite sides of the base fabric are formed respectively with a first bending section and a second bending section. Secondly, the first bending section and the second bending section of the base fabric are folded toward the first end surface of the base fabric, forming an opening above the first end surface between the first bending section and the second bending section. Thirdly, surfaces of the opening are coated with an adhesive and the base fabrics coated with the adhesive are stacked vertically that the adhesive on the lower base fabric is attached on the second end surface of the upper base fabric, allowing the base fabrics to be adhered and fixed by the adhesive.

### RELATED APPLICATION

This application is a Continuation-In-Part of currently pending U.S. patent application Ser. No. 13/418,791 filed on 2012 Mar. 13.

### BACKGROUND OF THE INVENTION

a) Field of the Invention

The present invention relates to a method of making a window blind and more particularly to a method of making a blind that the blind is made totally by a machine and is bonded without any manual joint (machine sewing).

b) Description of the Prior Art

A window blind is used by every family or in every indoor space. Most of the existing blinds are controlled by cords to unfold or collect rows in order to expand or retract the blinds.

Referring to FIG. 1 and FIG. 2, it shows an existing blind in fully expanded and partially retracted positions. Most of the blinds on existing markets are a layer-like body that is suspended vertically, as shown in the drawings. This layer-like body is formed by sewing rows B manually and joining a vertical load at a rear side of the row B. When the blind is collected, the vertical load should be driven by a cord A to collect the blind; whereas, plural annular bodies C arranged in parallel will be formed after retracting the blind. An ordinary blind should be partially retracted to manifest layers of annular body C.

However, as shown in the drawings, when the blind is unfolded, a layer-like body will be formed, with the cords A being disposed at the back side of the blind. Therefore, whether the blind is fully or partially expanded or retracted, the cords A will be suspended between the rows B and the window (not shown in the drawings). Although the cords A are not exposed outside the rows B, there is a distance between the rows B and the window, and thus, when a child is playing the blind, he or she can be strangled by the cords A easily because these cords are between the rows B and the window and very easy to reach. This becomes a major safety issue in the daily life of child, as in the real world, it is often heard that a child is accidentally strangled by the cords A of a blind, resulting in a regret that cannot be made up. Moreover, for the existing blind, there will be a lot of joints of manual sewing on the rows, which spoils integrity and beautifulness of the rows.

### SUMMARY OF THE INVENTION

Accordingly, the primary object of the present invention is to provide a method of making a window blind, and more particularly a method of making a blind that the blind is made totally by a machine and is bonded without any manual joint (machine sewing). In addition, the rows can manifest the layers of annular body in a blind without retracting the blind.

To achieve the abovementioned object, the method of making a blind, according to the present invention, is composed of following steps. Firstly, plural base fabrics are cut out, and each base fabric is provided with a first end surface and a second end surface, with two opposite sides of each base fabric being formed respectively with a first bending section and a second bending section. Secondly, the first bending section and the second bending section of each base fabric are folded toward the first end surface of the base fabric, and an opening is made above the first end surface between the first bending section and the second bending section. Thirdly, a surface of the opening is coated with an adhesive, and each base fabric coated with the adhesive is stacked vertically that the adhesive on the lower base fabric is attached on the second end surface of the upper base fabric, thereby allowing the base fabrics to be attached and fixed together through the adhesive.

Wherein, the width of the first bending section is smaller than the width of the second bending section, such that the opening between the first bending section and the second bending section will not be disposed at a center location of the base fabric.

Wherein, the opening on each base fabric is disposed on a same center line, which will manifest the layers of annular body in a blind without using a special manual sewing method or retracting the blind.

Wherein, each base fabric is further provided with a first bending line and the first bending section is folded toward the first end surface of the base fabric along the first bending line.

Wherein, each base fabric is further provided with a second bending line and the second bending section is folded toward the first end surface of the base fabric along the second bending line.

However, the features, benefits or similar descriptions disclosed in the specification should not be read to limit all the features and benefits to any single embodiment in the present invention. The disclosure of the features and the benefits should be construed instead as that the specific features, benefits or characteristics combined with the embodiment are included in at least one embodiment of the present invention. Therefore, the features, benefits and similar descriptions disclosed in the specification are unessentially related to the same embodiments.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional blind when rows are unfolded in a fully expanded position.

FIG. 2 shows a schematic view of the conventional blind after the rows have been partially retracted.

FIG. 3 shows a schematic view of a base fabric of the present invention.

FIG. 4 shows a schematic view of the base fabric of the present invention, wherein the base fabric has been bended on one side.

FIG. 5 shows a schematic view of the base fabric the present invention, wherein the base fabric has been bended on both sides.

FIG. 6 shows a schematic view of the base fabric of the present invention, wherein the base fabric is coated with an adhesive after bending.

FIG. 7 shows a schematic view of the base fabrics of the present invention, wherein the base fabrics are stacked vertically.

FIG. 8 shows a schematic view of the base fabrics of the present invention, wherein the base fabrics have been stacked and attached together.

FIG. 8A shows a partially enlarged view of FIG. 8.

FIG. 9 shows a side view of the rows of the present invention, wherein the rows are unfolded.

FIG. 10 shows a three-dimensional schematic view of the rows of the present invention, wherein the rows are unfolded (a blind is in an expanded position).

FIG. 11 shows a schematic view of the rows of the present invention, wherein the rows are collected by cords (a blind is in a fully retracted position).

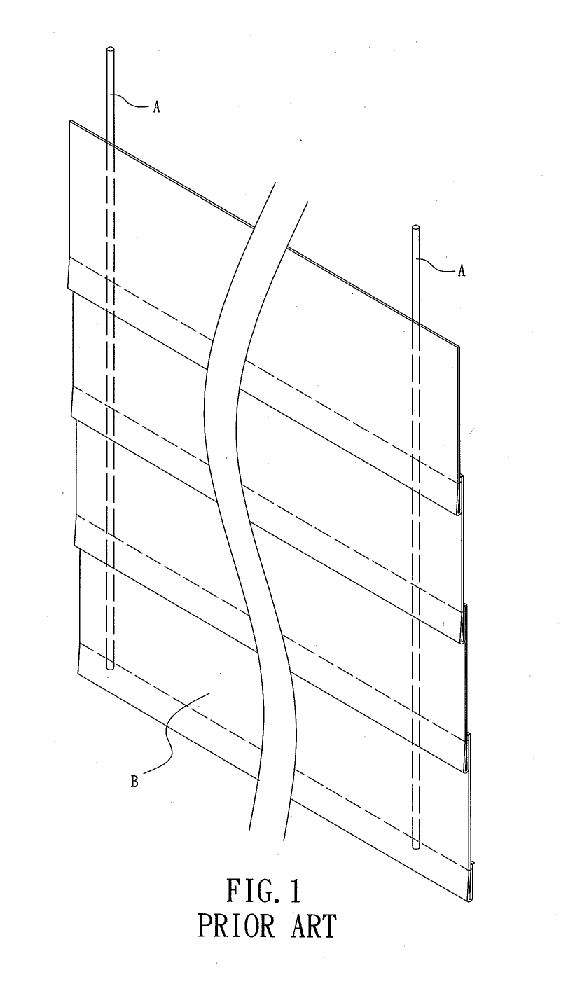

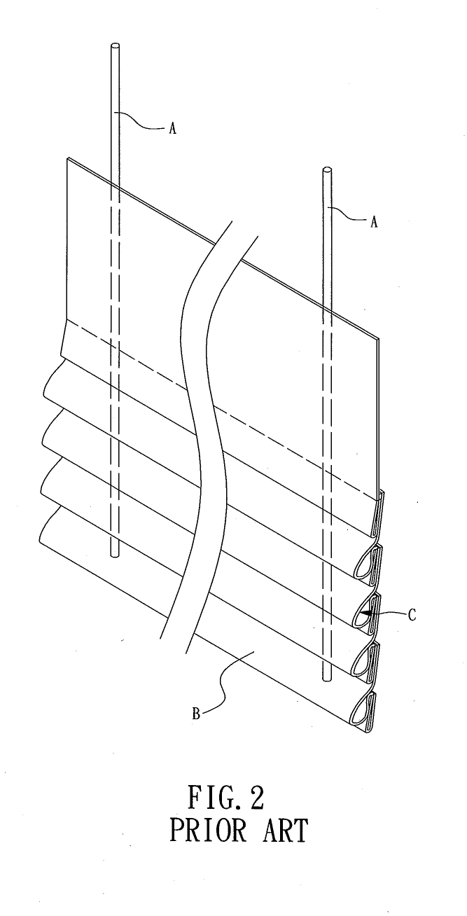

### DETAILED DESCRIPTION OF THE PREFERRED EMBODIMENTS

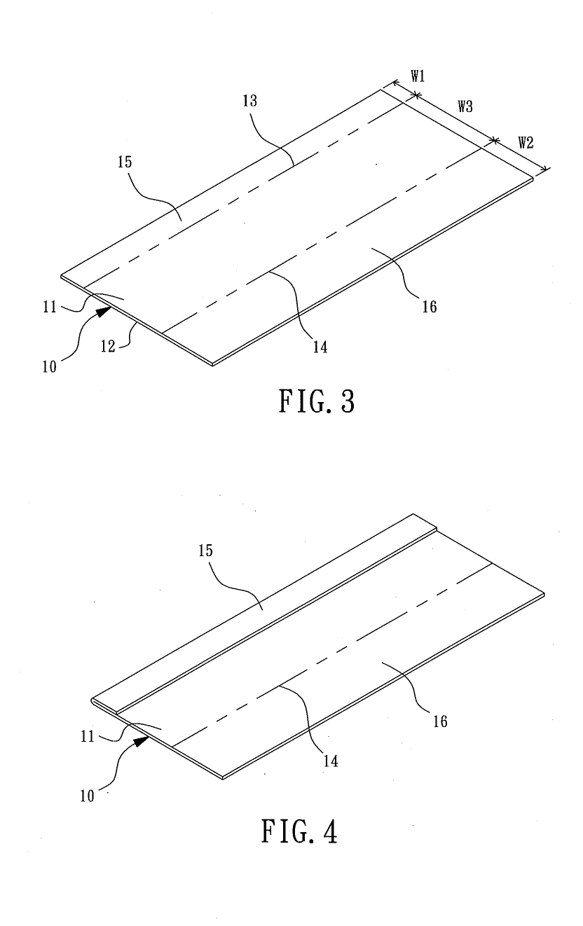

Referring to FIG. 3, a method of making a blind, according to the present invention comprises following steps. Firstly, plural base fabrics 10 are cut out, each base fabric 10 is provided with a first end surface 11 and a second end surface 12, and two opposite sides of the base fabric 10 are formed respectively with a first bending line 13 and a second bending line 14, wherein the first bending line 13 is extended outward with a first bending section 15, and the second bending line 14 is extended outward with a second bending section 16. In addition, the width W1 of the first bending section 15 is smaller than the width W2 of the second bending section 16, and the sum of the widths (W1+W2) of the first bending section 15 and the second bending section 16 is roughly smaller than the width W3 of the base fabric 10.

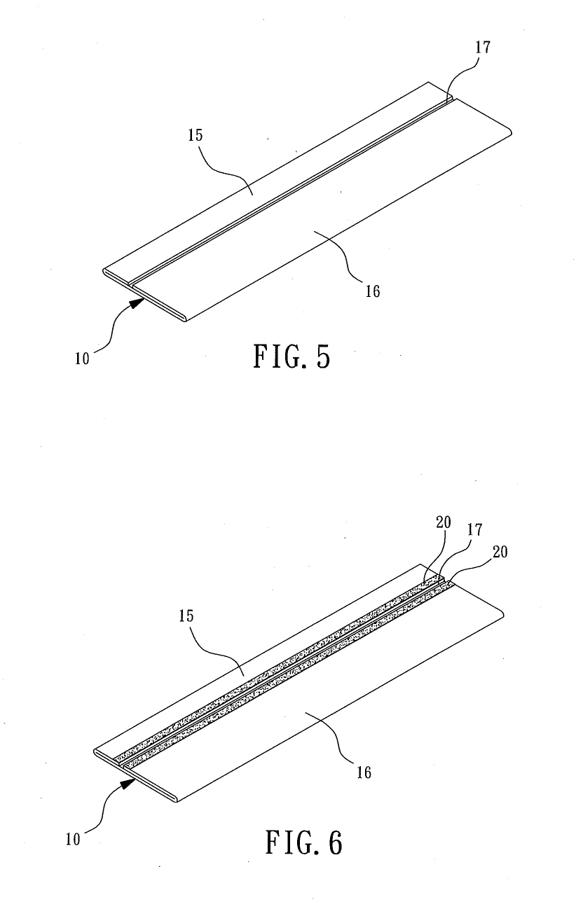

Secondly, folding is proceeded, as shown in FIG. 4 and FIG. 5. On each base fabric 10, the first bending section 15 is folded toward the first end surface 11 of the base fabric 10 against the first bending line 13, such that the first bending section 15 will be disposed above the first end surface 11. Next, the second bending section 16 is folded toward the first end surface 11 of the base fabric 10 against the second bending line 14, allowing the second bending section 16 to be disposed above the first end surface 11.

When the first bending section 15 and the second bending section 16 are folded above the first end surface 11 of the base fabric 10, as the sum of the widths (W1+W2) of the first bending section 15 and the second bending section 16 is a little smaller than the width W3 (as shown in FIG. 3) of the base fabric 10, an opening 17 will be formed between the first bending section 15 and the second bending section 16.

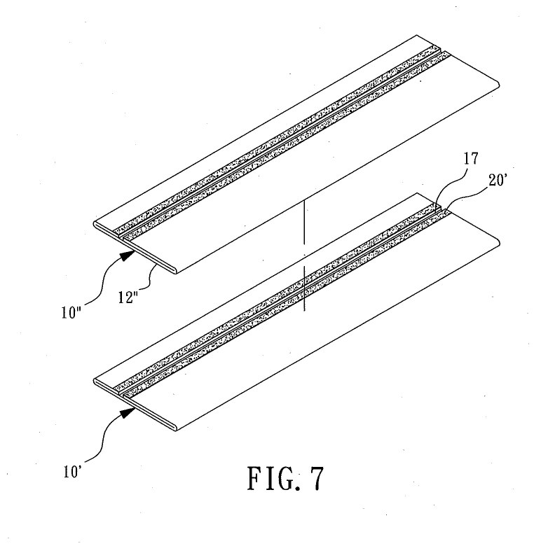

Thirdly, coating with an adhesive is proceeded. Referring to FIG. 6 and FIG. 7, surfaces of the first bending section 15 and the second bending section 16 in proximity to two sides of the opening 17 of the base fabric 10 are coated with an adhesive 20. Finally, attaching is conducted. The base fabrics 10 are stacked vertically that the adhesive 20′ on the lower base fabric 10′ is attached on the second end surface 12″ of the upper base fabric 10″, allowing the upper base fabric 10″ to be attached and fixed with the lower base fabric 10′.

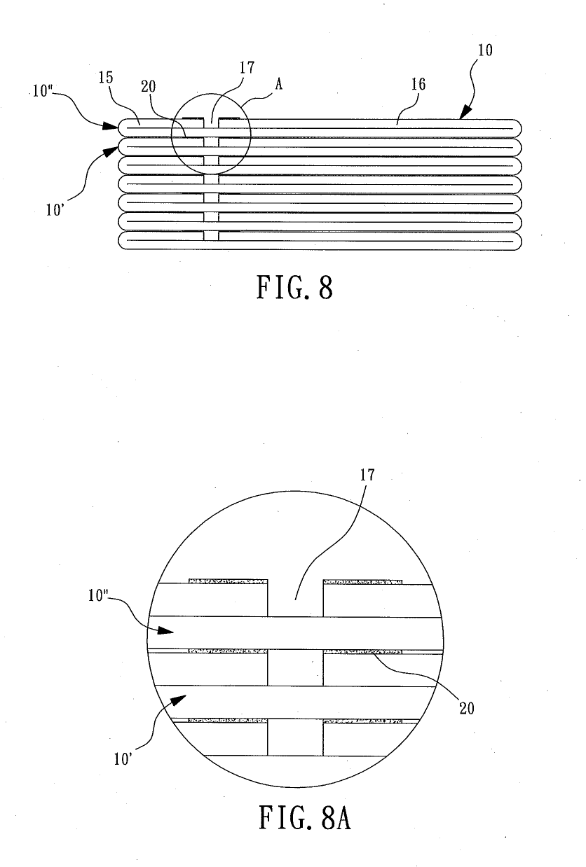

Referring to FIG. 8 and FIG. 8A, after the folded base fabrics 10 have been stacked vertically, the upper base fabric 10″ can be attached and fixed with the lower base fabric 10′ through the adhesive 20, allowing the opening 17 on the base fabric 10 to be disposed at a same center line. In addition, as the width of the first bending section 15 is smaller than the width of the second bending section 16, the opening 17 on the base fabric 10 is not disposed at a center location of the base fabric 10, but is disposed closer to the first bending section 15.

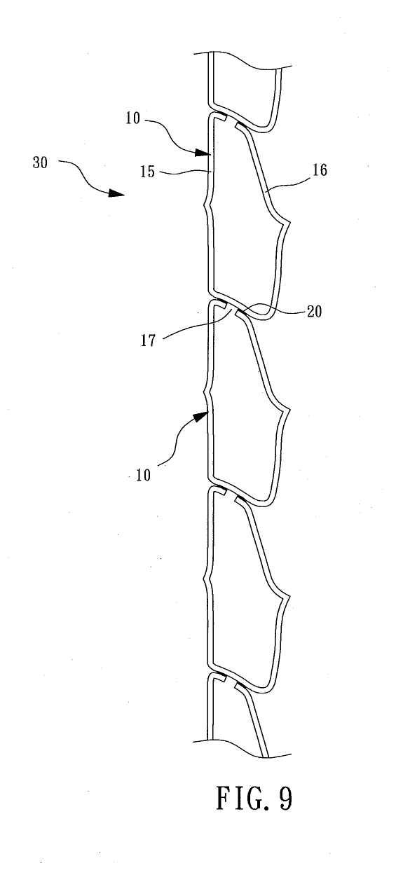

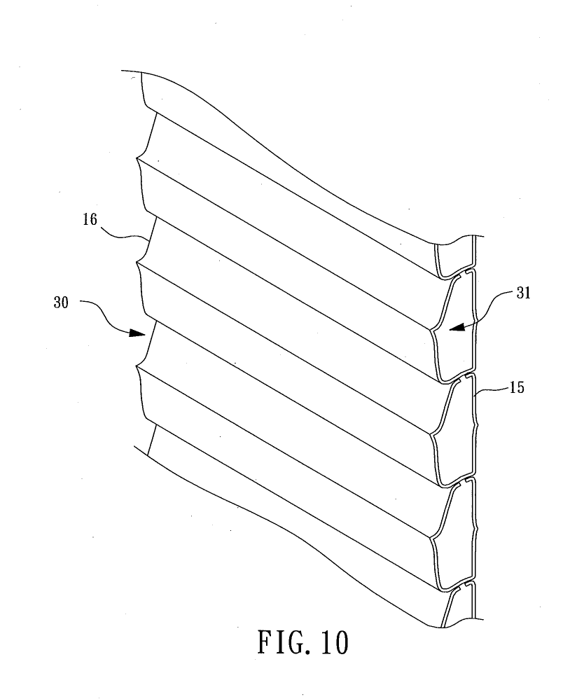

Referring to FIG. 9 and FIG. 10, a row 30 is formed after attaching and fixing every base fabric 10. When the row 30 is expanded, the opening 17 between the first bending section 15 and the second bending section 16 is not disposed at the center location of the base fabric 10, but is closer to the first bending section 15. Therefore, after the row 30 has been expanded, the end of each base fabric 10 closer to the first bending section 15 will be roughly in a vertical state due to gravity; whereas, the end of the base fabric 10 closer to the second bending section 16 will result in a blind effect. Therefore, when the entire row 30 is expanded, a profile of layers of annular body 31 can be manifested (forming a loop effect at the sides of the blind). Furthermore, the row 30 can be expanded or retracted without using a cord, because the rows 30 are attached together by an adhesive that the rows 30 can be driven as a whole. As no trace of manual sewing of an ordinary blind is exposed, the base fabrics 10 can be bonded evenly, cleanly and neatly. Besides that, the row 30 can be even beautified.

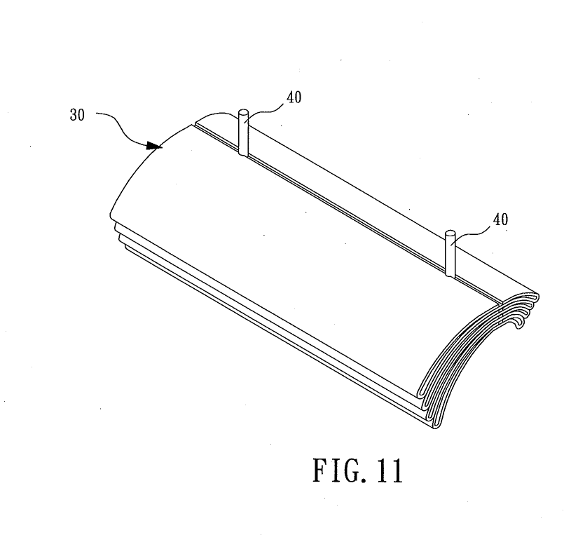

Lastly, referring to FIG. 11, when the rows 30 are to be retracted, cords 40 can be utilized, and while retracting, each base fabric can also manifest a state of layers of annular body. On the other hand, as the base fabrics are bonded together by the adhesive, no cords would be used in a real application and the rows can be retracted by winding. In other words, the rows of the present invention can be also used in a Roller Blind with an existing retractor (as it is a conventional technology, further description is not provided) to retract and expand the blind.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of making a window blind, comprising following steps:
cutting out plural base fabrics, with each base fabric being provided with a first end surface and a second end surface, and two opposite sides of the base fabric being formed respectively with a first bending section and a second bending section;
folding, with the first bending section and the second bending section of the base fabric being folded toward the first end surface of the base fabric, forming an opening above the first end surface between the first bending section and the second bending section; and
coating with an adhesive, with surfaces of the first bending section and the second bending section in proximity to the opening being coated with an adhesive, and the base fabrics coated with the adhesive being stacked vertically that the adhesive on the lower base fabric is attached on the second end surface of the upper base fabric, thereby adhering and fixing the base fabrics by the adhesive.

2. The method of making a window blind, according to claim 1, wherein the width of the first bending section is smaller than the width of the second bending section.

3. The method of making a window blind, according to claim 2, wherein the sum of the widths of the first bending section and the second bending section is smaller than the width of the base fabric.

4. The method of making a window blind, according to claim 1, wherein the opening of the base fabric is disposed on a same center line.

5. The method of making a window blind, according to claim 1, wherein the base fabric is further provided with a first bending line, and the first bending section is folded toward the first end surface of the base fabric along the first bending line.

6. The method of making a window blind, according to claim 5, wherein the base fabric is further provided with a second bending line, and the second bending section is folded toward the first end surface of the base fabric along the second bending line.
